(19) United States
(12) Patent Application Publication
(10) Pub. No.: US 2025/0330241 A1
(43) Pub. Date: Oct. 23, 2025

(54) BINARY-PIXEL OPTICAL COMMUNICATION SYSTEMS

(71) Applicant: X Display Company Technology Limited, Dublin (IE)

(72) Inventors: Ronald S. Cok, Rochester, NY (US); Imre Knausz, Fairport, NY (US)

(21) Appl. No.: 18/888,465

(22) Filed: Sep. 18, 2024

Related U.S. Application Data
(60) Provisional application No. 63/637,097, filed on Apr. 22, 2024.

(51) Int. Cl. H04B 10/11; G09G 3/14; H04N 25/70

(52) U.S. Cl. CPC H04B 10/11; G09G 3/14; H04N 25/70

(57) ABSTRACT

A binary-pixel optical communication system includes a binary-pixel display comprising binary display pixels operable to display a binary image and a binary-pixel camera comprising binary camera pixels disposed to optically receive the binary image and operable to record the binary image. The binary-pixel display and binary-pixel camera each include an array of single-bit storage circuits operable store a single bit of information corresponding to the binary image pixel and to receive or transmit a binary image pixel of the binary image. The binary-pixel display includes an array of light emitters each connected to a single-bit storage circuit forming a binary display pixel. The binary-pixel camera includes an array of photodetectors each connected to a single-bit storage circuit forming a binary camera pixel.

### PRIORITY APPLICATION

This application claims the benefit of U.S. Provisional Patent Application No. 63/637,097, filed on Apr. 22, 2024, the disclosure of which is hereby incorporated by reference herein in its entirety.

### CROSS REFERENCE TO RELATED APPLICATION

Reference is made to U.S. Patent Application No. 63/579,809 filed Aug. 30, 2023, entitled Optical Communication Systems with Displays by Cok et al., the disclosure of which is incorporated by reference herein in its entirety.

### TECHNICAL FIELD

The present disclosure relates generally to devices and methods for optical communication using binary images, a display, and a camera.

### BACKGROUND

Optical systems are widely used to communicate information between remote locations. Typical optical communication systems transmit optical signals from a laser to a photosensor through fiber optic cables. Some cables transmit a single signal through a single-mode fiber, other cables transmit multiple signals through a multi-mode fiber. Free-space optical systems transmit optical signals through free space (e.g., the atmosphere or outer space) with modulated laser light detected by a photosensor positioned within the laser beam.

There is an increasing need for communication bandwidth and computation to support such applications as artificial intelligence, internet search fulfilment, and internet services requiring internet-accessible computers. To support this need, a large number of computers must compute and communicate and are often co-located in data centers. Conventionally, the computers in a data center communicate electronically, for example through wired ethernet connections. More recently, fiber optic cables optically connect computers within a single data center. However, the physical size of the fiber optic cables, the length of the fiber optic cables, and the number of connections between the fiber optic elements and electronic equipment are becoming limitations on the computational capacity of connected computers within a data center.

There is a need, therefore, for improvements in devices and methods for optical communication.

### SUMMARY

The present disclosure provides, inter alia, architectures, structures, systems, devices, and methods for improved optical communication using optical systems comprising displays and cameras communicating binary optical signals. Such systems can provide increased communication bandwidth in smaller spaces with increased flexibility.

In some embodiments, a binary-pixel optical communication system can comprise a binary-pixel display comprising binary display pixels operable to display a binary image and a binary-pixel camera comprising binary camera pixels disposed to optically receive the binary image and operable to record the binary image. The binary-pixel camera can optically receive, absorb, record, or capture images from the binary-pixel display. In some embodiments, a binary image or image data displayed with binary display pixels of the binary-pixel display can be imaged by an optical system (e.g., comprising lenses or mirrors, or both) onto binary camera pixels of the binary-pixel camera.

The binary-pixel optical communication system can comprise a processor (e.g., a computer or CPU) connected to the binary-pixel camera or the binary-pixel camera can comprise a processor, computer, state-machine, or CPU operable to process the recorded image. (A CPU is a central processing unit.)

In some embodiments of a binary-pixel optical communication, a number or spatial resolution of the binary display pixels is spatially matched to a number or a spatial resolution of the binary camera pixels, respectively. The spatial resolution of the binary display pixels can be geometrically similar to the spatial resolution of the binary camera pixels. In some embodiments, at least one of the binary display pixels can be optically imaged to at least one of the binary camera pixels. For example, each of the binary display pixels can be optically imaged to one of the binary camera pixels. In some embodiments, at least one of the binary display pixels can be optically imaged to at least one group of multiple, adjacent binary camera pixels. In some embodiments, each of the binary display pixels can be optically imaged to at least one group of multiple, adjacent binary camera pixels. In some embodiments, the multiple, adjacent binary camera pixels can form a two-dimensional array.

In some embodiments, the binary-pixel display is operable to display a binary image at a display frame rate. In some embodiments, the binary-pixel camera comprises a camera sensor and a camera controller that controls the camera sensor to record a binary image at a camera frame rate that is equal to or greater than the display frame rate. The camera frame rate can be equal to or greater than twice the display frame rate.

According to embodiments of the present disclosure, a display comprises an array of single-bit storage circuits and an array of light emitters. Each single-bit storage circuit can be operable to store a single bit of information corresponding to a binary image pixel of a binary image and output the stored single bit of information. Each of the light emitters can be connected to a single-bit storage circuit of the single-bit storage circuits and operable to emit light corresponding to the output from the single-bit storage circuit. In some embodiments, the display can be a binary-pixel display comprising an array of single-bit storage circuits and an array of light emitters. Each single-bit storage circuit can be operable to receive a binary image pixel of a binary image, store a single bit of information corresponding to the binary image pixel, and output the stored single bit of information. Each light emitter can be connected to a single-bit storage circuit and can be operable to emit light corresponding to the output from the single-bit storage circuit. Each single-bit storage circuit and light emitter connected to the single-bit storage circuit can comprise a binary display pixel. Each light emitter can comprise an inorganic light-emitting diode (e.g., a micro-light-emitting diode having a maximum (e.g., a maximum length or maximum width) of no greater than 50 microns (e.g., no greater than 40, 30, 20, 15, 12, 10, 5, 2 or 1 micron).

In some embodiments, each single-bit storage circuit can be a latch, a flipflop, a static memory cell, or a dynamic memory cell. The binary display pixels can be arranged in a two-dimensional array comprising rows and columns and the write inputs of all of the single-bit storage circuits in each row can be connected together. Each light emitter in the array of light emitters can be separately connected to a corresponding single-bit storage circuit.

According to embodiments of the present disclosure, a binary display pixel can comprise a single-bit storage circuit and a light emitter. The single-bit storage circuit can be operable to receive a single bit of information and store the single bit of information. The light emitter can be responsive to the single bit of information stored in the single-bit storage circuit to emit light. Each single-bit storage circuit can be a latch, a flipflop, a static memory cell, or a dynamic memory cell. Each light emitter can be an inorganic light-emitting diode.

Some embodiments of the present disclosure comprise a display controller and the binary display pixels are separately connected to the display controller. Some embodiments of the present disclosure comprise binary display pixels each comprising only one of the light emitters and only one of the single-bit storage circuits. In some embodiments, the binary display pixels are arranged in a two-dimensional array comprising rows and columns and, for each of the rows, write inputs of all of the single-bit storage circuits in the row are connected together. In some embodiments, the binary display pixels are separately connected to the display controller. In some embodiments, each light emitter in the array of light emitters can be separately connected to a control wire through a corresponding single-bit storage circuit of the single-bit storage circuits. In some embodiments, the control wire can be connected to the display controller. In some embodiments, the single-bit storage circuits are separately connected to the display controller.

According to embodiments of the present disclosure, a method of controlling or using a binary-pixel display can comprise providing a binary camera, entering a single bit of information into each single-bit storage circuit, and outputting light from each light emitter corresponding to the single bit of information stored in the connected single-bit storage circuit. Some methods can comprise entering a single bit of information into all of the single-bit storage circuits at a same time. Some embodiments can comprise simultaneously outputting light from all of the light emitters corresponding to the single bit of information.

According to embodiments of the present disclosure, a binary-pixel camera can comprise an array of photodetectors and an array of single-bit storage circuits. Each photodetector can be responsive to light incident on the photodetector to provide a photosignal. Each single-bit storage circuit can be connected to a photodetector operable to receive the photosignal from the photodetector and store a single bit of information corresponding to the light incident on the photodetector. Each photodetector and single-bit storage circuit can be connected to the photodetector comprise a binary camera pixel. Each photodetector can comprise a photosensor responsive to light incident on the photosensor operable to provide a sensor signal and a converter (e.g., a MOSFET amplifier) responsive to the sensor signal to provide the photosignal. Each single-bit storage circuit can comprise a converter (e.g., a MOSFET amplifier) responsive to the photosignal operable to provide a bit signal and the single-bit storage circuits can be operable to store the bit signal as the single bit of information.

In some embodiments, each single-bit storage circuit can be a latch, a flipflop, a static memory cell, or a dynamic memory cell. Each photodetector can comprise a photo-diode, a pinned photo-diode, or a photo-transistor. Each single-bit storage circuit can comprise an output for the stored single bit of information. In some embodiments, each of the single-bit storage circuits can be operable to write a common bit value into the single-bit storage circuit in response to a clear signal provided on a clear input. The clear inputs of two-or-more or all of the single-bit storage circuits of each camera pixel can be connected together. In some embodiments, the single-bit storage circuit of each camera pixel can comprise a read-control signal and an output for the single-bit storage circuit. The outputs of columns of camera pixels can be connected together and the read-control signals of the camera pixels in each row of camera pixels can be connected together in a read-row-control signal. The single-bit storage circuit of each camera pixel can comprise an output for the single-bit storage circuit connected to a separate and distinct output connection (e.g., a wire). The camera pixels can be arranged in a two-dimensional array comprising rows and columns.

According to embodiments of the present disclosure, a binary-pixel camera can comprise a photodetector responsive to light incident on the photodetector to provide a photosignal and a single-bit storage circuit connected to the photodetector operable to receive the photosignal from the photodetector and store a single bit of information corresponding to the light incident on the photodetector. The photodetector can comprise a photosensor responsive to light incident on the photosensor operable to provide a sensor signal and a converter (MOSFET amplifier) responsive to the sensor signal to provide the photosignal. The single-bit storage circuit can be a latch, a flipflop, a static memory cell, or a dynamic memory cell. In some embodiments, the single-bit storage circuit is operable to write a common bit value into the single-bit storage circuit in response to a clear signal provided on a clear input.

According to embodiments of the present disclosure, a method of controlling a binary-pixel camera can comprise providing a binary camera, exposing the array of photodetectors to light to provide a photosignal for each photodetector, and storing each photosignal as a single bit of information corresponding to the light incident on the corresponding photodetector. A camera controller can be operable to read the bit values stored in the single-bit storage circuits. The camera controller can be operable to read the bit values stored in all of the single-bit storage circuits one row at a time. The binary camera pixels can be arranged in a two-dimensional array comprising rows and columns and the camera controller can be operable to read the bit values stored in the single-bit storage circuits one row at a time. Embodiments can comprise clearing each single-bit storage circuit by storing a common value (e.g., a zero) in the single-bit storage circuit.

According to embodiments of the present disclosure, a binary-pixel display can comprise a display substrate comprising a semiconductor. In some embodiments, the array of single-bit storage circuits can be formed in or on and can be native to the display substrate. In some embodiments, the array of light emitters can be disposed on and non-native to the display substrate or the array of light emitters can be formed in or on and can be native to the display substrate. In some embodiments, one or more of the single-bit storage circuits in the array of single-bit storage circuits can be disposed in an area over the display substrate formed or defined by a convex hull that includes the array of light emitters. Some embodiments comprise a display substrate and the array of single-bit storage circuits can be disposed on and can be non-native to the display substrate and the array of light emitters can be disposed on and can be non-native to the display substrate. In some embodiments, one or more of the single-bit storage circuits in the array of single-bit storage circuits can be disposed in an area over the display substrate formed or defined by a convex hull that includes the array of light emitters. In some embodiments, one or more of the single-bit storage circuits in the array of single-bit storage circuits can comprise a micro-integrated circuit comprising a fractured or separated tether.

According to embodiments of the present disclosure, a binary-pixel camera can comprise a camera substrate comprising a semiconductor. The array of single-bit storage circuits can be formed in or on and can be native to the camera substrate. The array of photodetectors can be disposed on and non-native to the camera substrate. The array of photodetectors can be formed in or on and can be native to the camera substrate. In some embodiments, one or more of the single-bit storage circuits in the array of single-bit storage circuits can be disposed in an area over the camera substrate formed or defined by a convex hull that includes the array of photodetectors. Some embodiments can comprise a camera substrate. The array of single-bit storage circuits can be disposed on and can be non-native to the camera substrate. The array of photodetectors can be disposed on and non-native to the camera substrate. In some embodiments, one or more of the single-bit storage circuits in the array of single-bit storage circuits is disposed in an area over the camera substrate formed or defined by a convex hull that includes the array of photodetectors. In some embodiments, one or more of the single-bit storage circuits in the array of single-bit storage circuits can comprise a micro-integrated circuit comprising a fractured or separated tether.

In some embodiments of the present disclosure, a display pixel cluster comprises binary display pixels and a display cluster controller disposed on the display substrate between two or more binary display pixels. The display cluster controller can be operable to control two or more binary display pixels in the display pixel cluster. In some embodiments, a camera pixel cluster comprises binary camera pixels and a camera cluster controller disposed on the camera substrate between two or more binary camera pixels. The camera cluster controller can be operable to control two or more binary camera pixels in the camera pixel cluster.

Some embodiments comprise a camera circuit disposed on the camera substrate that is electrically connected and operable to control or receive signals from one, two, or three or more binary camera pixels. Similarly, some embodiments comprise a display circuit disposed on the display substrate that is electrically connected and operable to control one, two, or three or more binary display pixels to emit light. In some embodiments, the display or camera circuits can be thin-film circuits formed in or on and native to the display substrate or camera substrate, respectively, the display or camera substrate can be a semiconductor substrate, the display or camera circuits can be formed in or on and native to one or more layers of the display substrate, or the display or camera circuits can be non-native circuits having a circuit substrate separate and independent from and non-native to the display or camera substrate formed in a separate source wafer and transferred to the display or camera substrate, for example using micro-transfer printing, and can comprise fractured or separated tethers.

In some embodiments, a binary-pixel camera can comprise a camera controller operable to read the single bit of information stored in the single-bit storage circuits.

According to some embodiments of the present disclosure, a camera can comprise an array of camera pixels that are operable to capture binary images. The camera can be operable to record the binary images.

According to some embodiments of the present disclosure, a method can comprise displaying an image on a display, capturing the image with a camera, wherein the image is captured as a binary image, and recording the binary image. The image can be a binary image. The method can be performed as part of a data communication process. The method can be performed as part of a data transfer process. Each pixel of the image corresponds to a separate communication channel.

In some embodiments of the present disclosure, a method of communicating data can comprise displaying a binary image with a display and capturing the binary image. Each pixel of the binary image can correspond to a separate communication channel.

In some embodiments, a camera circuit or a display circuit (or circuit wiring) can be disposed on a camera or display substrate between binary camera or display pixels on the camera or display substrate.

In some embodiments of the present disclosure, the binary camera or display pixels are monochrome pixels that absorb (receive) or emit the same color of light. In some embodiments, the binary camera or display pixels are color pixels comprising subpixels that each emit a different color of light.

According to embodiments of the present disclosure, a method of operating a binary-pixel optical communication system can comprise displaying a binary image with the binary display pixels in the binary-pixel display, exposing light from the binary-pixel display onto the binary camera pixels of the binary-pixel camera, for example using an optical system, capturing the binary image with the binary camera pixels in the binary-pixel camera, recording the captured binary image, e.g., in a memory internal or external to the binary-pixel camera, and processing the recorded binary image. In some embodiments, the recorded binary image is processed to extract a value from the light emitted by each of the binary display pixels. In some embodiments, the binary display pixels (or pixel values) displayed are binary values and the image pixels captured, recorded, or processed are binary values.

Some embodiments of the present disclosure comprise capturing or recording all of the binary pixels in a binary image at a first time or during a first time period before capturing or recording one or more of the binary pixels in a binary image at a second time after the first time or during a second period after the first period. Some embodiments comprise capturing or recording all of the binary pixels at a same time. Some embodiments comprise sequentially capturing or recording rows of the binary pixels or sequentially capturing or recording columns of the binary pixels.

Embodiments of the present disclosure provide improvements in devices and methods for optical communication using a display and digital camera, in particular due to display and/or capture of binary (e.g., as opposed to grayscale) images. For example, conventional complementary metal-oxide-semiconductor (CMOS) cameras are known to be poor at capturing grayscale images (and therefore generally charge-coupled devices (CCDs) are usually preferred for such application). However, embodiments of the present disclosure using circuits that capture image pixels in binary mitigate such poor performance. Therefore, embodiments of the present disclosure can benefit from advantage(s) of cheap and easy manufacturing of CMOS technology without the associated downsides. As another example, while certain binary displays, such as electrophoretic displays, exist and could be captured with a conventional camera, there will be issues with bleeding from pixel to pixel, among others. Embodiments of the present disclosure do not suffer from such bleeding. Embodiments disclosed herein capture images in binary (e.g., with a binary-pixel camera) instead of recording images as binary that were captured in grayscale, by, for example, thresholding.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1A is a schematic diagram of a binary-pixel optical communication system with inset enlargements of a binary-pixel display and a binary-pixel camera according to illustrative embodiments of the present disclosure;

FIG. 1B is a schematic diagram of a binary-pixel optical communication system comprising a binary-pixel display with an inset enlargement of a binary display pixel and a binary-pixel camera with an inset enlargement of a binary camera pixel according to illustrative embodiments of the present disclosure;

FIGS. 2A-2C are circuit diagrams of single-bit storage circuits for storing binary values according to illustrative embodiments of the present disclosure;

FIGS. 3A-3D are circuit diagrams of binary display pixels according to illustrative embodiments of the present disclosure;

FIG. 4 is a schematic diagram of a binary-pixel display with directly controlled binary display pixels according to illustrative embodiments of the present disclosure;

FIG. 5 is a schematic diagram of a binary-pixel display with matrix-controlled binary display pixels according to illustrative embodiments of the present disclosure;

FIG. 6 is a schematic diagram of a binary-pixel cluster of a binary-pixel display with directly controlled binary display pixels according to illustrative embodiments of the present disclosure;

FIGS. 7A-7C are circuit diagrams of photodetectors according to illustrative embodiments of the present disclosure;

FIGS. 8A-8C are circuit diagrams of binary camera pixels according to illustrative embodiments of the present disclosure;

FIG. 9 is a schematic diagram of a binary-pixel camera with directly controlled binary camera pixels according to illustrative embodiments of the present disclosure;

FIG. 10 is a schematic diagram of a binary-pixel camera with matrix-controlled binary camera pixels according to illustrative embodiments of the present disclosure;

FIG. 11 is a schematic diagram of a binary-pixel cluster of a binary-pixel camera with directly controlled binary camera pixels according to illustrative embodiments of the present disclosure;

FIG. 12 is a schematic diagram of a matrix-addressed binary-pixel cluster having matrix-addressed binary pixels for a binary-pixel display or a binary-pixel camera according to illustrative embodiments of the present disclosure;

FIG. 13 is a flow diagram of methods according to embodiments of the present disclosure;

FIGS. 14A-14C are cross sections of binary display pixels according to illustrative embodiments of the present disclosure; and

FIGS. 15A-15E are cross sections of binary camera pixels according to illustrative embodiments of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The figures are not necessarily drawn to scale.

### DETAILED DESCRIPTION OF CERTAIN EMBODIMENTS

Free-space optical communication systems can suffer from limited bandwidth because of a corresponding limitation in the number of communication channels and the data rate of each communication channel. Embodiments of the present disclosure provide, among other things, free-space communication systems with multiple optical communication channels providing increased bandwidth using binary images having binary pixel elements in a binary-pixel display and a corresponding binary-pixel camera. For example, each binary display pixel in a digital binary-pixel display can provide a free-space optical communication channel detected by one or more corresponding binary camera pixels in a digital binary-pixel camera. If each binary pixel is a monochrome pixel emitting a single color of light, each binary pixel can be a separate and individual free-space optical communication. If each pixel is a color pixel having multiple subpixels each emitting different colors of light in a color binary-pixel display, each binary color subpixel can provide a separate and individual free-space optical communication channel detected by a color digital binary-pixel camera.

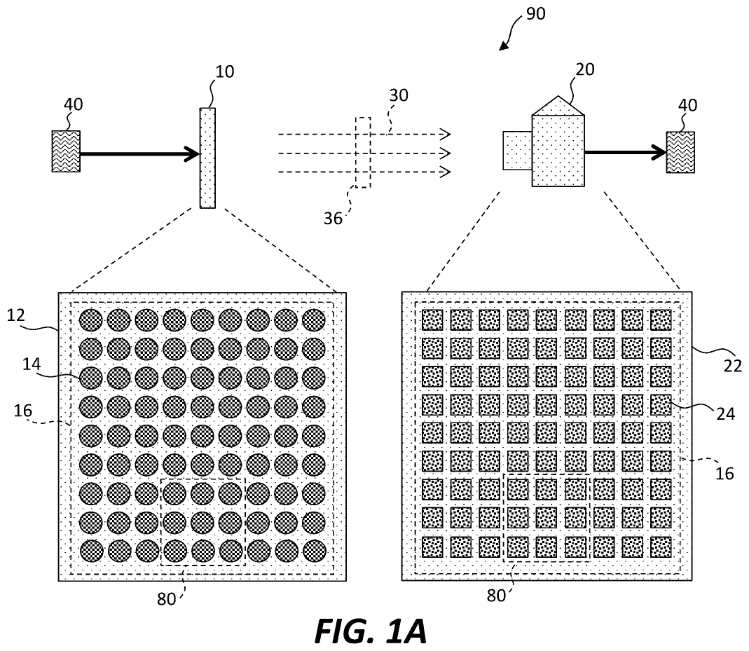

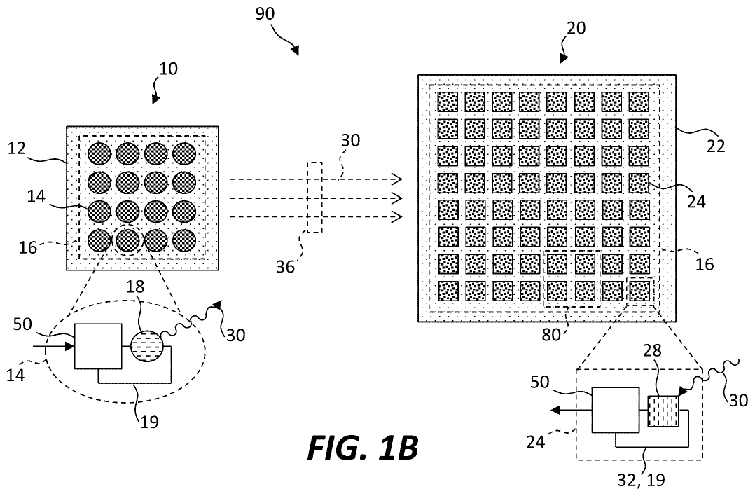

According to some embodiments of the present disclosure and as shown in FIGS. 1A and 1B, a binary-pixel optical communication system 90 can comprise a binary-pixel display 10 comprising binary display pixels 14 operable to display a binary image 40 and a binary-pixel camera 20 comprising binary camera pixels 24 disposed to optically receive the displayed binary image 40 and operable to record the binary image 40, for example in a memory. Light 30 output from binary display pixels 14 of binary-pixel display 10 can pass through an optical system 36 (e.g., comprising one or more lenses, light pipes, reflectors, or diffractors) and impinge upon and be detected by (received by) binary camera pixels 24 of binary-pixel camera 20.

Binary display pixels 14 can be disposed on a display substrate 12 in a two-dimensional array within a pixel area 16 (e.g., a convex hull surrounding binary display pixels 14) and can be grouped into clusters 80. Similarly, binary camera pixels 24 can be disposed on a camera substrate 22 within a pixel area 16 (e.g., a convex hull surrounding binary camera pixels 24) and can be grouped into clusters 80. Binary-pixel optical communication system 90 can comprise a memory (e.g., a digital memory) or a processor (e.g., a CPU) connected to binary-pixel camera 20 or binary-pixel camera 20 can comprise a memory or processor operable to store the received and recorded binary image 40. Binary-pixel camera 20 can capture a binary image 40 shown on binary-pixel display 10 and record the captured image in the memory. The recorded image can be accessed and processed by the processor, CPU, or computer.

According to embodiments of the present disclosure, the use of binary display pixels 14 in binary-pixel display 10 reduces the complexity and size of the circuits in binary-pixel display 10, enabling a faster operation (e.g., an increased frame rate) and greater resolution (e.g., more binary display pixels 14 per unit area of binary-pixel display 10) thereby increasing the optical bandwidth and improving the density and reducing the size of binary-pixel display 10, thereby improving operational efficiency and reducing costs. Similarly, the use of binary camera pixels 24 in binary-pixel camera 20 reduces the complexity and size of the circuits in binary-pixel camera 20, enabling a faster operation (e.g., an increased frame rate) and greater resolution (e.g., more binary camera pixels 24 per unit area of binary-pixel camera 20) thereby increasing the optical bandwidth and improving the density and reducing the size of binary-pixel camera 20, thereby improving operational efficiency and reducing costs. The use of binary information can also improve a signal-to-noise ratio of binary-pixel optical communication system 90. For example, and in contrast to embodiments of the present disclosure, analog storage capacitors and multi-bit digital storage devices can be relatively large and complex in digital circuits, displays, cameras, and communication systems, increasing costs and size, and reducing the signal-to-noise ratio of the system. According to some embodiments of the present disclosure, the number of binary display pixels 14 is spatially matched to the number of binary camera pixels 24, for example as shown in FIG. 1A. According to some embodiments of the present disclosure and as also shown in FIG. 1A, the spatial resolution of binary display pixels 14 is spatially matched to the spatial resolution of binary camera pixels 24. In some embodiments, the spatial resolution of binary display pixels 14 is geometrically similar to the spatial resolution of binary camera pixels 24. For example, the number of binary display pixels 14 and the number of binary camera pixels 24 can be the same but the pixel area 16 of binary camera pixels 24 in pixel area 16 on camera substrate 22 can be larger (or smaller) than pixel area 16 of binary display pixels 14 in pixel area 16 on display substrate 12. Hence, as shown in FIG. 1A, the spatial resolution of binary display pixels 14 can be the same as or geometrically similar to the spatial resolution of binary camera pixels 24. In some embodiments, the pixel pitch range can be from one micron to six mm. In some embodiments, the pixel spatial resolution can be from one micron to six mm.

In some embodiments, at least one of binary display pixels 14 is optically imaged to at least one of binary camera pixels 24, for example by optical system 36, and as shown in FIG. 1A. For example, each of binary display pixels 14 can be optically imaged to one of binary camera pixels 24 by optical system 36. In some embodiments, at least one of binary display pixels 14 is optically imaged to at least one group of multiple, adjacent binary camera pixels 24, as shown in FIG. 1B in which each binary display pixel 14 is imaged to a two-by-two array (e.g., cluster 80) of binary camera pixels 24. In some embodiments, each of binary display pixels 14 is optically imaged to at least one separate and different group of multiple, adjacent binary camera pixels 24. As shown, the multiple, adjacent binary camera pixels 24 form a two-dimensional array, as can the clusters 80 of multiple, adjacent binary camera pixels 24. Adjacent binary display pixels 14 are binary display pixels 14 between which there is no other binary display pixel 14, for example in a direction. Similarly, adjacent binary camera pixels 24 are binary camera pixels 24 between which there is no other binary camera pixel 24, for example in a direction.

Binary-pixel display 10 can display binary images 40 at a display frame rate, for example a number of binary images 40 per second. In some embodiments, binary-pixel camera 20 comprises a camera sensor, for example comprising binary camera pixels 24, and a camera controller 71 (e.g., an electrical circuit that controls the camera sensor to record a binary image 40 at a camera frame rate. The camera frame rate can be greater than or equal to the display frame rate. In some embodiments, the camera frame rate is a positive integer multiple greater than one of the display frame rate. In some embodiments, the camera frame rate is equal to or greater than twice the display frame rate. Such a greater frame rate can ensure that binary-pixel camera 20 records all of binary images 40 displayed on binary-pixel display 10 over time.

Binary-pixel optical communication systems 90 can comprise a binary-pixel display 10 comprising a display substrate 12 and an array of binary display pixels 14 disposed in a pixel area 16 on or over display substrate 12. As shown in the binary display pixel 14 inset of FIG. 1B, each binary display pixel 14 can comprise a single-bit storage circuit 50 operable to receive a single bit of information and store the single bit of information and a corresponding light emitter 18 electrically connected to single-bit storage circuit 50 that can emit light 30 in response to the single bit stored in single-bit storage circuit 50. Single-bit storage circuits 50 can comprise an electrical circuit and can comprise a flipflop, a latch, a static memory cell (SRAM), or a dynamic memory cell (DRAM) constructed in an integrated circuit native to, or non-native to, display substrate 12, for example an electrical circuit operable to store a single binary bit, for example as a charge or a voltage. Each single-bit storage circuit 50 can be operable to receive a binary image pixel of a binary image 40, store a single bit of information corresponding to the binary image pixel, and output the stored single bit of information to light emitter 18. Each light emitter 18 can be, for example, an inorganic micro-light-emitting diode 18 disposed on and non-native to display substrate 12 and can be operable to emit light 30 corresponding to the output from single-bit storage circuit 50 in response to a suitable voltage or current provided by single-bit storage circuit 50. Each single-bit storage circuit 50 and light emitter 18 connected to single-bit storage circuit 50 can comprise a binary display pixel 14.

In some embodiments, display substrate 12 or camera substrate 22 is a semiconductor substrate and single-bit storage circuits 50 can be electrical circuits (e.g., integrated circuits) formed in and native to the semiconductor substrate. In some embodiments, display substrate 12 or camera substrate 22 is not a semiconductor substrate (for example is a glass or plastic substrate) and single-bit storage circuits 50 can be electrical circuits disposed on and non-native to the substrate, for example disposed by micro-transfer printing one or more single-bit storage circuits 50 from a circuit source wafer as an integrated circuit to display substrate 12 or camera substrate 22 and interconnected with electrodes 19 using photolithography.

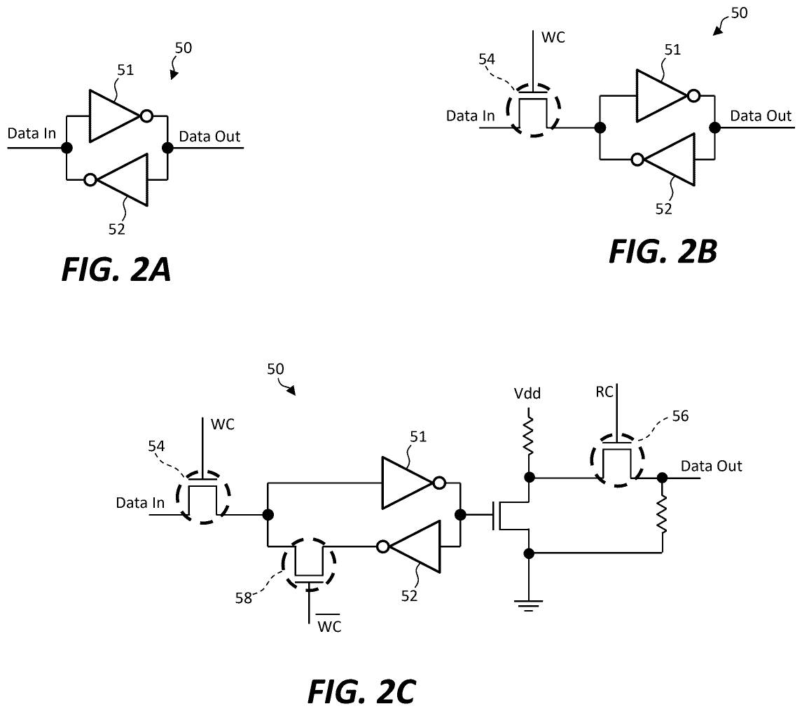

As shown in FIGS. 2A-2C, single-bit storage circuits 50 can comprise a variety of electrical circuit designs. In some embodiments and as shown in FIG. 2A, a single-bit storage circuit 50 can comprise two inverters, first logic inverter 51 and second logic inverter 52, electrically connected with the output of each inverter connected to the input of the other inverter so that the input of first logic inverter 51 is connected to the output of second logic inverter 52 and the output of first logic inverter 51 is connected to the input of second logic inverter 52. A voltage (e.g., data input corresponding to a binary bit) applied to an inverter input is stored in single-bit storage circuit 50 through the electrical action of the oppositely connected inverters (providing a stable electrical state in the inverter storage circuit) and the inverted data output with an opposite polarity of single-bit storage circuit 50 is available at the output of the inverter storage circuit.

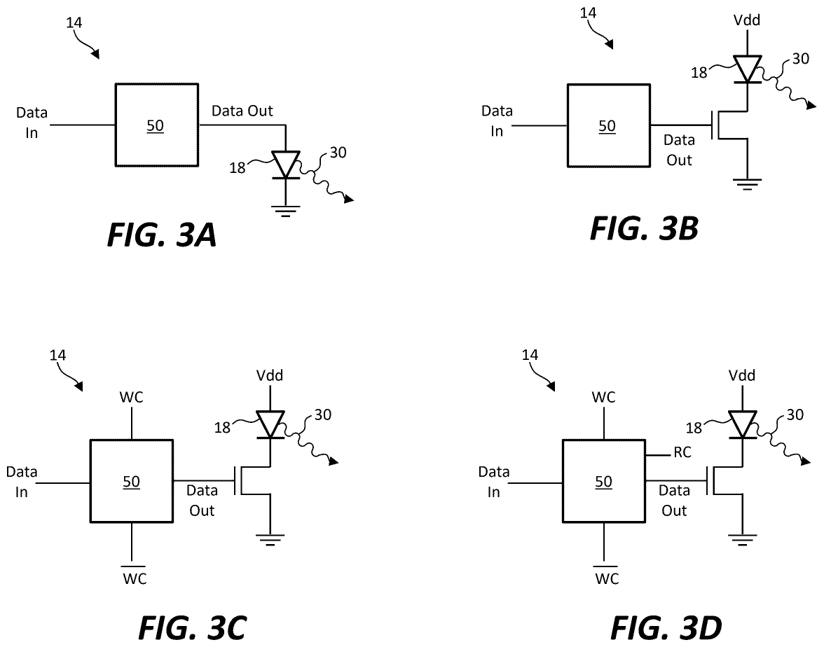

As shown in FIG. 2B, a write-control transistor 54 responsive to a write-control (WC) signal can control writing (e.g., storing) a binary bit into single-bit storage circuit 50 by switching the data input to the inverter storage circuit. FIG. 2C illustrates more complex embodiments having an additional inverted write-control transistor 58 to prevent conflicting signals on the input of the invertor storage circuit, an inverter at the output of the connected inverters to provide a data output having a polarity corresponding to the data input, and a read-control transistor 56 switch that controls access to the data output. The data output (when the read control signal is disabled) defaults to a low voltage (indicating no light output to save optical energy). In some embodiments, some or all of write-control or read-control signals of single-bit storage circuits 50 are electrically connected together so that some or all of binary display pixels 14 are written to or read from at the same time in response to a common write or read signal. The circuits illustrated in FIGS. 2A-2C are provided for understanding various options and embodiments of the present disclosure. Circuit designers will appreciate that other more complete and more complex circuit designs can provide improved performance and can be included in some embodiments of the present disclosure. Single-bit storage circuits 50 can be disposed on display substrate 12 between binary display pixels 14 in pixel area 16. FIGS. 3A-3C illustrate various embodiments of the present disclosure that can use any of the single-bit storage circuits 50 of FIGS. 2A-2C. As shown in FIGS. 3A-3C, a binary display pixel 14 can comprise a single-bit storage circuit 50 operable to receive a single bit of information, for example from a binary pixel in a binary image and a light emitter 18 (e.g., a micro-light-emitting diode 18) responsive to the single bit of information stored in the single-bit storage circuit 50 to emit light 30. In FIG. 3A, the output from single-bit storage circuit 50 directly drives a light-emitting diode 18 that emits light 30 in response to the data stored in single-bit storage circuit 50, for example corresponding to single-bit storage circuit 50 of FIG. 2A. FIG. 3B illustrates an amplification transistor 59 responsive to the data output from single-bit storage circuit 50 driving light emitter 18. FIG. 3C illustrates embodiments with more complex control circuits (e.g., comprising write-control signals as in single-bit storage circuits 50 of FIGS. 2B and 2C) with amplification transistor 59. FIG. 3D illustrates embodiments with more complex control circuits (e.g., comprising write-control and read-control sub-circuits as in single-bit storage circuits 50 of FIG. 2C) with amplification transistor 59. The circuits illustrated in FIGS. 3A-3D are provided for understanding various options and embodiments of the present disclosure. Circuit designers will appreciate that other more complete and more complex circuit designs can provide improved performance and can be included in some embodiments of the present disclosure.

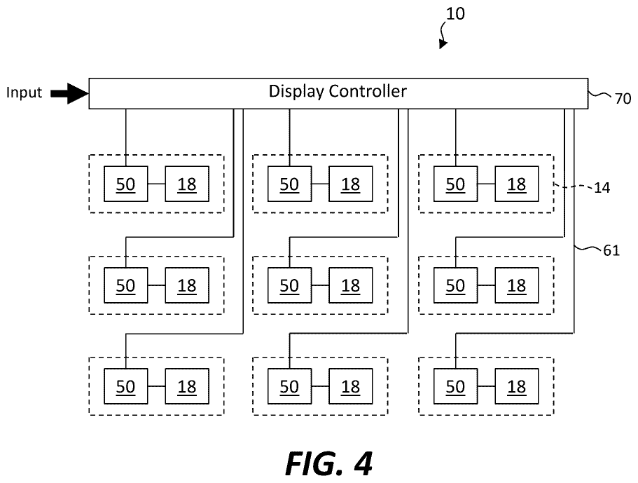

Each binary display pixel 14 in binary-pixel display 10 can be directly controlled by a display controller 70 through a control wire 61, as shown in FIG. 4 so that each light emitter 18 in the array of light emitters 18 is separately connected to a corresponding single-bit storage circuit 50. By providing direct control, every binary display pixel 14 can be updated at any time and operable all of the time, without using matrix addressing through row and column wires. In some embodiments, all or some of single-bit storage circuits 50 can be organized as a digital memory responsive to a write (or a read) address provided by a controller such as display controller 70 (or a cluster controller 82, discussed below). Each of single-bit storage circuits 50 can correspond to a bit in the memory. Thus, a four-by-four array of binary display pixels 14 can have sixteen single-bit storage circuits 50 that are bits in a sixteen-bit-wide memory. An eight-by-eight array of binary display pixels 14 can have sixty-four single-bit storage circuits 50 that are bits in a sixty-four-bit-wide memory. In such embodiments, all of single-bit storage circuits 50 can be written at a time by entering a single bit of information into all of single-bit storage circuits 50 at a same time with a single address and corresponding light 30 immediately emitted from connected light emitters 18 of binary display pixels 14. Binary-pixel display 10 can be operated by providing a binary image 40 and entering a single bit of information into each single-bit storage circuit 50 and outputting light 30 from each light emitter 18 corresponding to the single bit of information stored in the connected single-bit storage circuit 50. Thus, each light emitter 18 in the array of light emitters 18 is separately connected to a corresponding single-bit storage circuit 50.

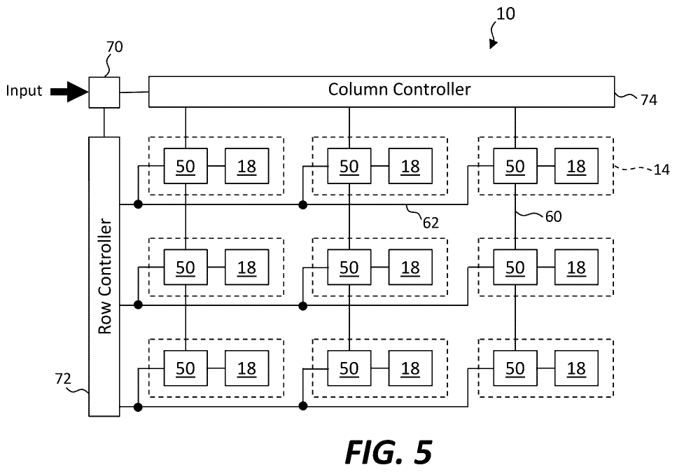

In some embodiments and as shown in FIG. 5, each binary display pixel 14 is controlled in rows and columns with a row controller 72 and column controller 74 (e.g., comprised in display controller 70) using matrix addressing in which rows of binary display pixels 14 connected with row wires 62 are updated at a time through column wires 60. In such embodiments, binary display pixels 14 can be arranged in a two-dimensional array comprising rows and columns and the write-control inputs of all of single-bit storage circuits 50 in each row can be connected together, thereby enabling writing to a row of single-bit storage circuits 50 at a same time for matrix addressing.

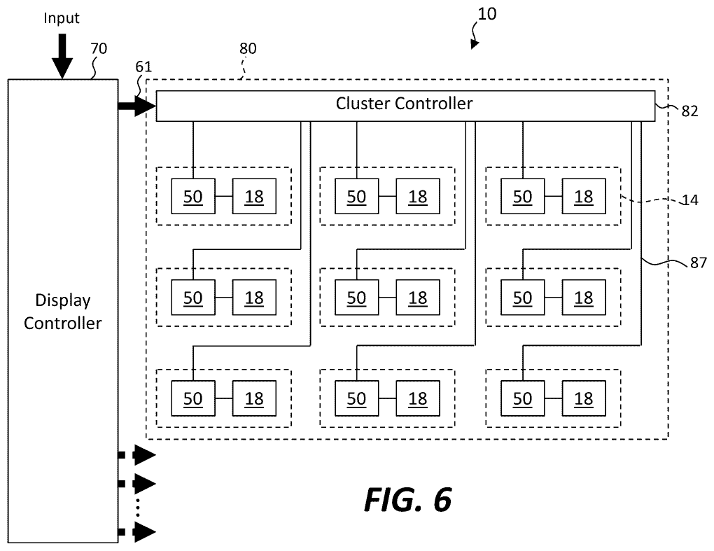

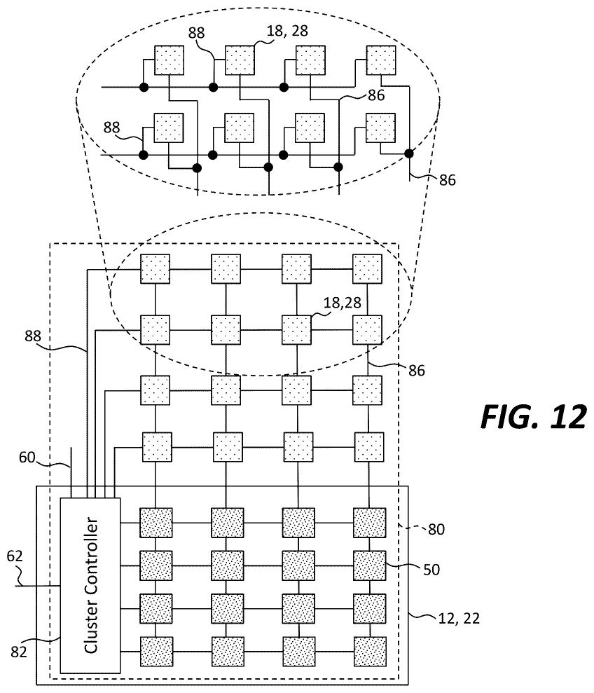

Groups of binary display pixels 14 in the array of binary display pixels 14 can be controlled in clusters 80 as shown in FIG. 6. A display controller 70 can provide binary pixel data from corresponding portions of binary image 40 to a cluster controller 82 controlling binary display pixels 14 in clusters 80. Binary display pixels 14 in cluster 80 can be directly controlled from cluster controller 82 using cluster control wires 87 (as shown in FIG. 6) or can be controlled using matrix addressing with cluster column wires 86 and cluster row wires 88 (as shown in FIG. 12). Cluster controllers 82 can be disposed between binary display pixels 14 on display substrate 12 (e.g., disposed within the display pixel area 16 of binary-pixel display 10). Binary-pixel display 10 can comprise multiple clusters 80. Each of multiple clusters 80 can be directly controlled from display controller 70 (as shown in FIG. 6 using control wires 61) or can be controlled using matrix addressing (shown in FIG. 12 with row and column wires 62, 60 and as in FIG. 5 for binary display pixels 14). FIG. 6 illustrates a single cluster 80 under the direct control of display controller 70 but in some embodiments display controller 70 can control multiple clusters 80 (illustrated with the dashed heavy arrows).

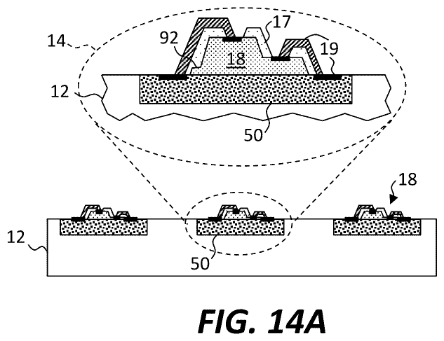

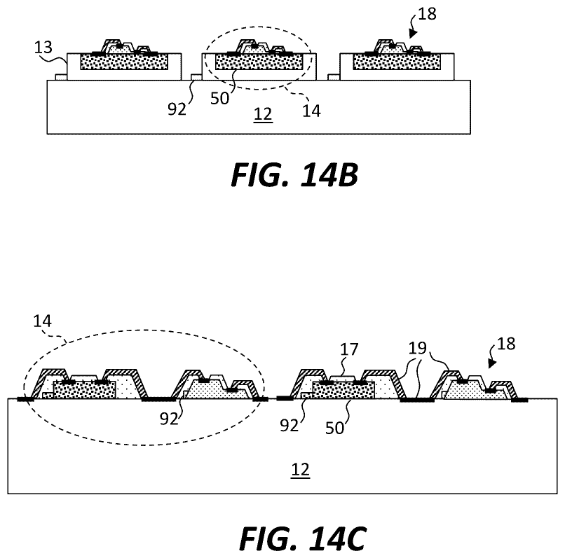

Light emitters 18 (e.g., light-emitting diodes 18) in binary display pixels 14 can be micro-light-emitting diodes 18 disposed on display substrate 12 using micro-transfer printing and can comprise a fractured or separated tether 92 (shown in FIGS. 14A, 14C). Micro-transfer printing enables the integration of micro-sized light-emitting diodes 18 in high-resolution displays, for example having a maximum (e.g., a maximum length or maximum width) of no greater than 50 microns (e.g., no greater than 40, 30, 20, 15, 12, 10, 5, 2 or 1 micron).

According to embodiments of the present disclosure and as illustrated in FIGS. 1A and 1B, a binary-pixel camera 20 can comprise photodetectors 28 disposed in a two-dimensional array and an array of corresponding single-bit storage circuits 50. Each photodetector 28 can be responsive to light 30 incident on photodetector 28 to provide a photosignal 32 (e.g., carried on electrode 19). Each single-bit storage circuit 50 can be connected to a corresponding photodetector 28 and can be operable to receive photosignal 32 from photodetector 28 and store a single bit of information corresponding to light 30 incident on photodetector 28. Each photodetector 28 and single-bit storage circuit 50 connected to photodetector 28 comprise a binary camera pixel 24. Binary-pixel camera 20 can comprise a camera substrate 22 and binary camera pixels 24 disposed on camera substrate 22. Binary camera pixels 24 can be controllable to capture (e.g., absorb) light 30 to produce an electrical charge or current, for example converting a charge to a voltage using a pixel circuit local to each binary camera pixel 24.

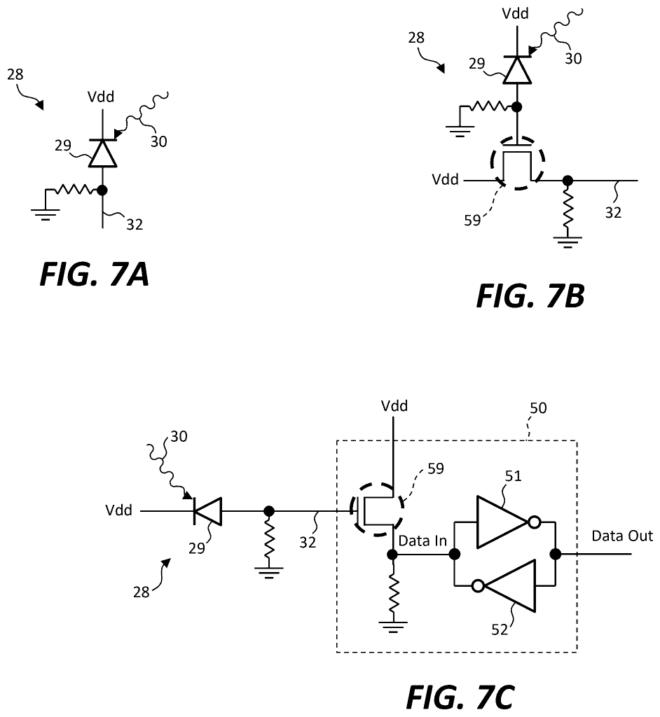

As shown in FIGS. 7A-7C, photodetector 28 of binary camera pixel 24 can comprise a photosensor 29 such as a photodiode 29, pinned photo-diode 29, or phototransistor 29 that absorbs light 30 to produce electrical charge or current, e.g., a photosignal 32. In some embodiments, binary camera pixel 24 can comprise multiple photosensors 29 that each absorb light 30 of a different color to produce an electrical current or charge. Photosensors 29 that each absorb light 30 of a different color can, for example, comprise color filters. As shown in FIG. 7A, photosensor 29 of photodetector 28 can directly produce a sensor signal in response to incident light 30 that is photosignal 32. In some embodiments and as shown in FIG. 7B, the sensor signal produced by photosensor 29 in response to incident light 30 is converted, for example amplified by an amplification transistor 59 (e.g., a MOSFET) responsive to photosensor 29 to provide photosignal 32. In some embodiments and as shown in FIG. 7C, the converter (e.g., amplification transistor 59) is comprised in single-bit storage circuit 50 and can be schematically similar to FIG. 7B. The converter (e.g., MOSFET amplification transistor 59) can be responsive to photosignal 32 (or the photosensor 29 signal) to provide a bit signal and the single-bit storage circuit 50 can be operable to store the bit signal as the single bit of information. Amplification transistor 59 can be useful if the power (current or voltage) produced by photosensor 29 is too small to provide an input signal to single-bit storage circuit 50. Amplification transistor 59 can be a part of photodetector 28 or single-bit storage circuit 50 and can function similarly in either embodiment.

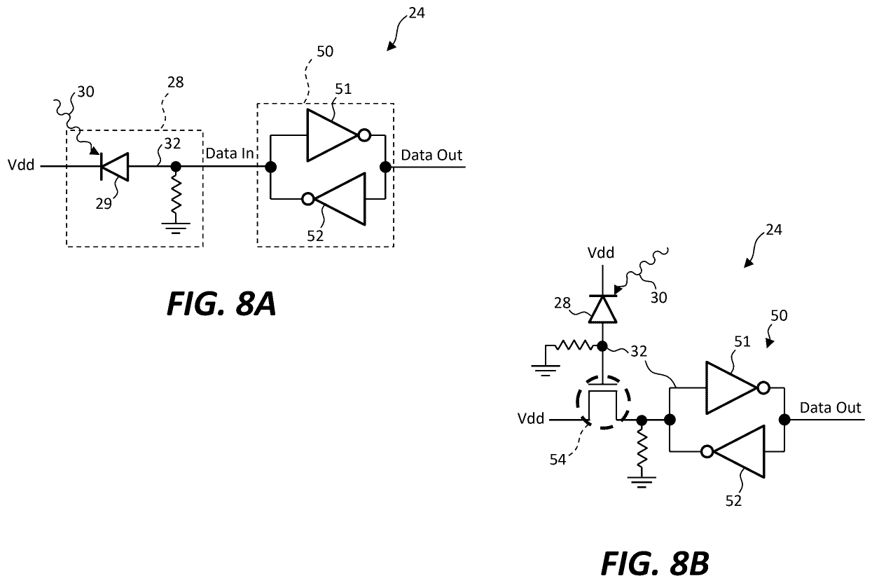

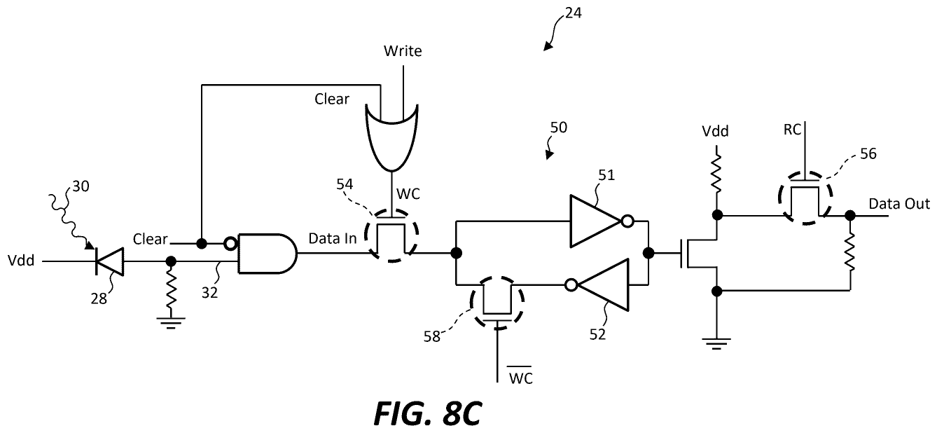

FIG. 8A illustrates embodiments of binary camera pixel 24 comprising photodetector 28 of FIG. 7A and single-bit storage circuit 50 of FIG. 2A. In operation in FIG. 8A, light 30 incident on photosensor 29 creates a charge or current (photosignal 32) that is sufficient to provide a data input voltage (e.g., a logic one) stored in single-bit storage circuit 50 (e.g., as described with respect to FIGS. 2A-2C). In the absence of light incident on photosensor 29, the data input voltage can be ground (e.g., a logic zero). The provided voltage can then be stored in single-bit storage circuit 50.

FIGS. 7B, 7C, and 8B are functionally equivalent designs that illustrate embodiments of binary camera pixel 24 comprising a write-control transistor 54 (e.g., corresponding to FIG. 2B). Write-control transistor 54 can be functionally equivalent to amplification transistor 59 and photosignal 32 can be either the input to write-control transistor 54 or the output of amplification transistor 59. In operation, light 30 incident on photosensor 29 creates a charge or current (photosignal 32) that is sufficient to turn on amplification transistor 59 (also serving as a write-control transistor 54) to provide an input data voltage (equal to Vdd) to single-bit storage circuit 50.

FIG. 8C illustrates embodiments having more complex control logic (and corresponding to FIG. 2C). The photosensor 29 circuit is as described with respect to FIGS. 7A-8B. The embodiments of FIG. 8C also incorporates logic for clearing single-bit storage circuit 50. The clear signal applied to a clear input wire, when low (inactive) has no effect on the Data In signal and the value is written into single-bit storage circuit 50 in response to a write signal. When high, the clear signal will force the Data In signal to a low value and cause a write signal to write the low value into single-bit storage circuit 50. The OR gate is optional, as the write signal can be controlled separately from the clear signal (e.g., a clear signal is applied, and a separate write signal writes the low value into single-bit storage circuit 50). In response to a read signal, the stored signal can be read out from single-bit storage circuit 50 (or an inverted stored signal without the output inverter).

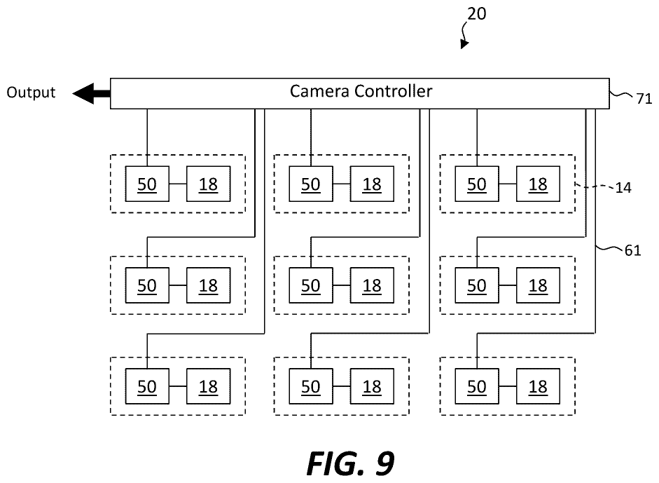

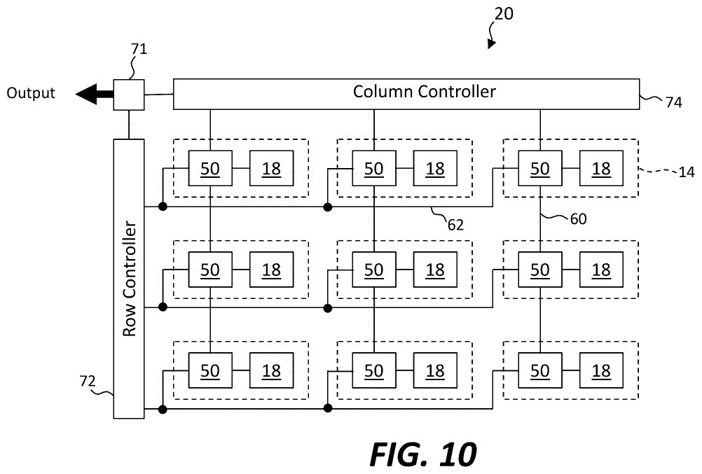

By connecting the clear signals of multiple (or all) binary camera pixels 24 together, a common bit value (e.g., a low value) can be written into the connected binary camera pixels 24 at a same time in response to a clear signal provided on the clear inputs of each binary camera pixels 24, thus clearing single-bit storage circuits 50 of binary camera pixels 24. Similarly, each single-bit storage circuit 50 of each binary camera pixel 24 can comprise a read-control sub-circuit and an output for the single-bit storage circuit 50. The read-control sub-circuits can be electrically connected together so that all of binary camera pixels 24 can be read at a same time, for example as a multi-bit binary value having bits corresponding to the value of each binary camera pixel 24, e.g., in a directly controlled design. In such a design, each output of each binary camera pixel 24 can be connected to a separate and distinct output connection (e.g., a control wire 61) connected to binary camera controller 71, as shown in FIG. 9. In some embodiments, binary camera pixels 24 are arranged in a two-dimensional array comprising rows and columns, outputs of columns of binary camera pixels 24 are connected together, and the read-control sub-circuits of the binary camera pixels 24 in each row of camera pixels are connected together in a read-row-control signal to provide a matrix-controlled design controlled by a camera controller 71, as shown in FIG. 10.

The circuit diagrams of FIGS. 7A to 8C are simplified designs provided for illustrative purposes. For example, the designs do not necessarily provide means for clearing photosensor 29 (e.g., for image-frame capture) or enable photosignal 32 responsive to light 30 integrated over time rather than an instantaneous photosignal 32. Other embodiments can comprise a variety of sensing circuits used to detect charges accumulated by a photo-detector, for example a current-mode readout circuit and conveyor read-out circuit. Some embodiments can comprise a photodetector 28 comprising a single-photon avalanche diode and can, in some embodiments, operate without the illustrated resistors in a sensing circuit (e.g., photodetector 28). The single-bit storage circuits 50 in binary camera pixels 24 can be the same as those in binary display pixels 14.

Each binary camera pixel 24 in binary-pixel camera 20 can be directly controlled by a camera controller 71 through a control wire 61, as shown in FIG. 9 so that each photodetector 28 in the array of photodetectors 28 is separately connected to a corresponding single-bit storage circuit 50. By providing direct control, every binary camera pixel 24 can be read at any time and operable all of the time, without using matrix addressing through column and row wires 60, 62 as shown in FIG. 10. In some embodiments, all or some of single-bit storage circuits 50 can be organized as a memory responsive to a read (or write) address provided by a controller such as a camera controller 71 (or a cluster controller 82, discussed below). Each of single-bit storage circuits 50 can correspond to a bit in the memory. Thus, a four-by-four array of binary camera pixels 24 can have sixteen single-bit storage circuits 50 that are bits in a sixteen-bit-wide memory. An eight-by-eight array of binary camera pixels 24 can have sixty-four single-bit storage circuits 50 that are bits in a sixty-four-bit-wide memory. In such embodiments, all of single-bit storage circuits 50 can be read at a time at a same time with a single address. Binary-pixel camera 20 can be operated by reading a binary image from binary-pixel camera 20 and storing the single bits of information read from each single-bit storage circuit 50. Thus, each photodetector 28 in the array of photodetectors 28 is separately connected with a control wire 61 to a corresponding single-bit storage circuit 50.

In some embodiments and as shown in FIG. 10, each binary camera pixel 24 is controlled in rows and columns with a row controller 72 and column controller 74 (e.g., comprised in camera controller 71) using matrix addressing, in which case rows of binary camera pixels 24 connected with row wires 62 are read at a time through column wires 60. In such embodiments, binary camera pixels 24 can be arranged in a two-dimensional array comprising rows and columns and the read inputs of all of single-bit storage circuits 50 in each row can be connected together, thereby enabling reading from a row of single-bit storage circuits 50 at a same time for matrix addressing.

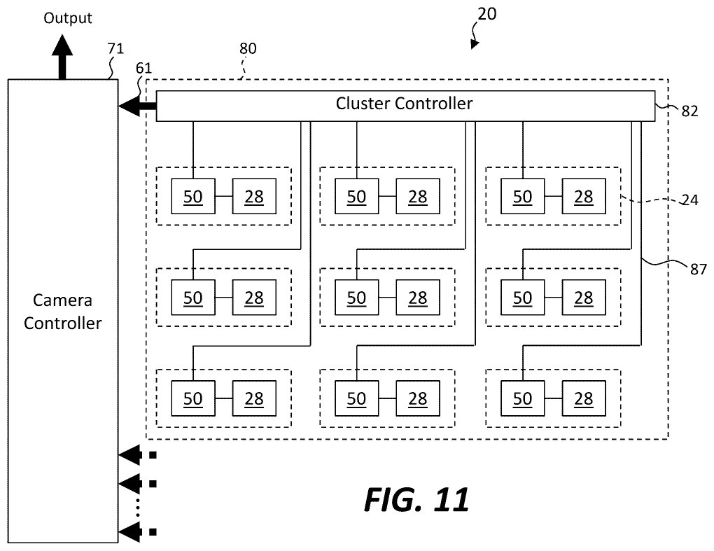

Groups of binary display pixels 14 can be controlled in clusters 80 as shown in FIG. 11. A camera controller 71 can read binary pixel data from corresponding portions of binary image 40 from a cluster controller 82 controlling binary camera pixels 24 in clusters 80. Cluster controllers 82 can be disposed between binary camera pixels 24 on camera substrate 22. Binary camera pixels 24 in cluster 80 can be directly controlled from cluster controller 82 (as in FIG. 11) using cluster control wires 87 or can be controlled using matrix addressing (as shown in FIG. 12) using cluster row wires 88 and cluster column wires 86. A binary-pixel camera 20 can comprise multiple clusters 80. Each of multiple clusters 80 can be directly controlled from camera controller 71 (as shown in FIG. 11 using control wires 61) or can be controlled using matrix addressing (as shown in FIG. 12 using cluster controller 82 comprising row and column controllers 72, 74 using row and column wires 62, 60 as in FIG. 10). FIG. 11 illustrates a single cluster 80 under the direct control of display controller 70 but, in some embodiments, camera controller 71 can control multiple clusters 80 (illustrated with the dashed heavy arrows). Photodetectors 28 (e.g., comprising photosensors 29 such as photodiodes 29) in binary camera pixels 24 can comprise micro-photosensors 29 disposed on camera substrate 22 using micro-transfer printing and can comprise a fractured or separated tether 92. Micro-transfer printing enables the integration of micro-sized photosensors 29 in high-resolution cameras, for example having a maximum (e.g., a maximum length or maximum width) of no greater than 50 microns (e.g., no greater than 40, 30, 20, 15, 12, 10, 5, 2 or 1 micron). In some embodiments, photosensors 29 can be made in silicon and are integral and non-native to a photodetector 28 or binary camera pixel 24, for example integrated into a common structure with single-bit storage circuit 50 in binary-pixel camera 20 on a semiconductor camera substrate 22.

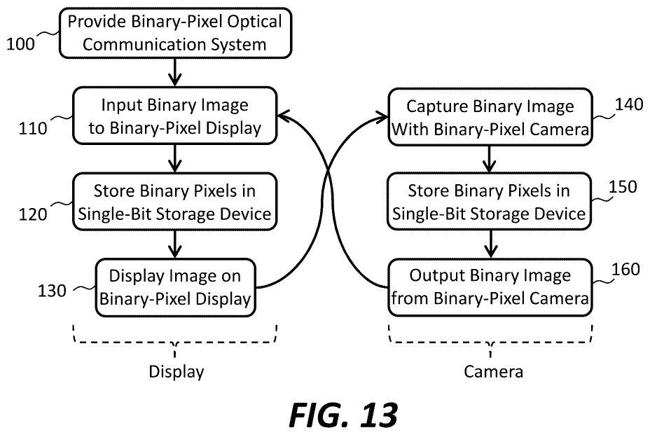

According to embodiments of the present disclosure and as shown in FIG. 13, a method of operating a binary-pixel optical communication system 90 comprises providing the binary-pixel optical communication system 90 (e.g., as shown in FIGS. 1A and 1B) in step 100. A binary image 40 comprising binary pixel values is input (e.g., from an external binary image source such as a computer or communication system and encoding digital binary information) to binary-pixel display 10 (e.g., using electrical, optical, or electro-optic circuits) in step 110. The binary pixel values are stored (e.g., under the control of display controller 70) in corresponding single-bit storage circuits 50 in step 120 by entering a single bit of information into each single-bit storage circuit 50. The image corresponding to the stored binary pixels is then displayed on light-emitting diodes 18 of binary display pixels 14 of binary-pixel display 10 in step 130 by outputting light 30 from each light emitter 18 corresponding to the single bit of information stored in the connected single-bit storage circuit 50. In some embodiments, a single bit of information is entered into all of single-bit storage circuits 50 at a same time.

Once binary image 40 is displayed on binary-pixel display 10, light 30 is emitted from light-emitting diodes 18 through an optional optical system 36 to binary-pixel camera 20, thereby exposing the array of photodetectors 28 to light 30 to provide a photosignal 32 for each photodetector 28 in step 140. Each photosignal 32 is stored as a single bit of information corresponding to the light 30 incident on the corresponding photodetector 28 to capture the corresponding binary bits with binary camera pixels 24 and the captured binary bits are stored in single-bit storage circuits 50 in step 150. Camera controller 71 is then operable to read the bit values stored in the single-bit storage circuits 50 and output the stored binary bits from binary-pixel camera 20 in step 160. In some embodiments, camera controller 71 is operable to directly read the bit values stored in all of the single-bit storage circuits 50 at a time. In some embodiments, the binary camera pixels 24 are arranged in a two-dimensional array comprising rows and columns and camera controller 71 is operable to read the bit values stored in the single-bit storage circuits 50 one row at a time. In some embodiments, each single-bit storage circuit 50 is cleared by storing a common value (e.g., a zero) in the single-bit storage circuit 50. The binary image 40 communication process can then repeat by returning to step 110. In some embodiments, binary-pixel camera 20 can be synchronized with binary-pixel display 10, for example optically or electronically. In other embodiments, binary-pixel camera 20 runs open loop at a frame rate greater than that of binary-pixel display 10.

Embodiments of the present disclosure can comprise single-bit pixel frame stores to enable pipe-lined operation, for example in storing an input image or an output image. Such frame stores can comprise arrays of single-bit storage circuits 50. In some embodiments, binary image 40 captured by binary-pixel camera 20 can be output (read) from binary-pixel camera 20 at the same time that a binary image 40 is stored (written) into binary-pixel display 10 (e.g., read from and written to arrays of single-bit storage circuits 50 in binary-pixel cameras 20 and binary-pixel displays 10, respectively. Binary-pixel optical communication system 90 can comprise differential signal circuits, for example in single-bit storage circuits 50.

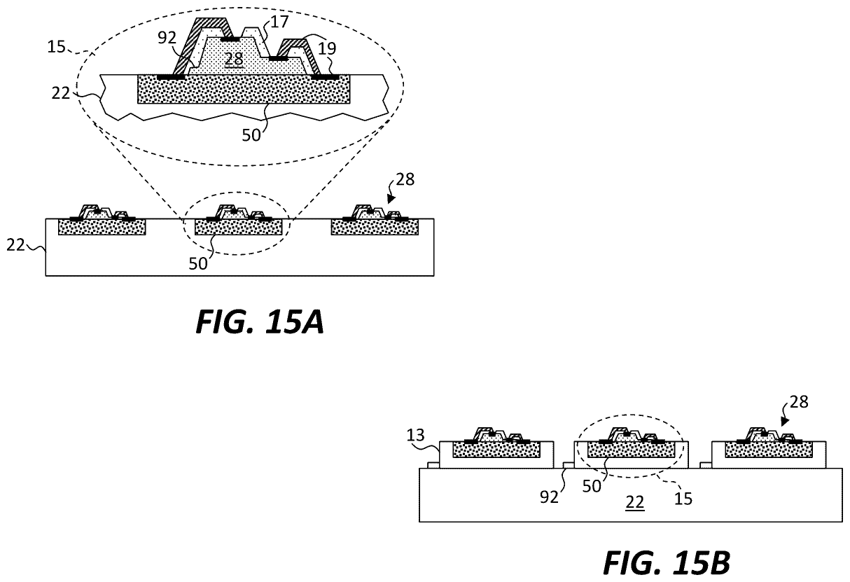

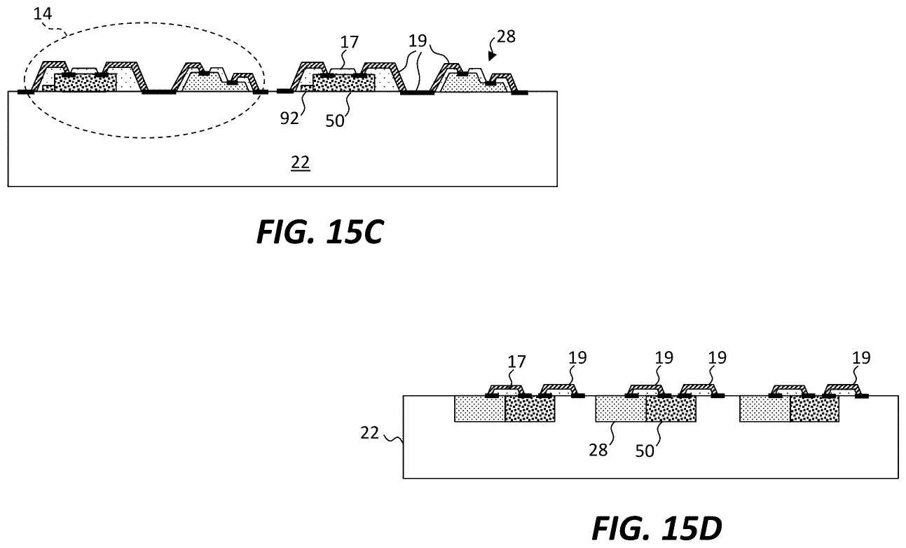

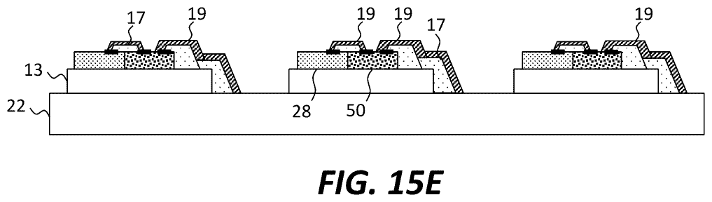

In some embodiments of the present disclosure, binary display pixels 14 and light-emitting diodes 18 can be disposed on or in display substrate 12 in a variety of ways. In some embodiments and as shown in FIG. 15A, binary-pixel display 10 comprises a display substrate 12 comprising a semiconductor and the array of single-bit storage circuits 50 is formed in or on and is native to display substrate 12. The array of light emitters 18 can be disposed on and non-native to display substrate 12, for example where the semiconductor is silicon and light emitters 18 are not, e.g., by micro-transfer printing light emitters 18 from a source wafer to display substrate 12. In some embodiments (not shown), the array of light emitters 18 can be formed in or on and is native to display substrate 12, for example where a semiconductor material 18 is comprised in and suitable for both light emitters 18 and display substrate 12. Each light emitter 18 can be insulated with a dielectric structure 17 and can comprise a light-emitter contact pad electrically connected to a substrate contact pad with an electrode 19 that contacts both the light-emitter contact pad and the substrate contact pad and is patterned over dielectric structure 17. (Contact pads and electrodes 19 are not always distinguished in the Figures.) The substrate contact pad can be electrically connected to single-bit storage circuit 50 with electrodes 19. In some embodiments and to increase binary-pixel display 10 resolution, light-emitters 18 can be disposed on or over single-bit storage circuits 50, as shown in FIG. 14A, reducing the area on display substrate 12 needed for each binary display pixel 14 and increasing binary-pixel display 10 resolution. Thus, one or more (e.g., all) of single-bit storage circuits 50 in the array of single-bit storage circuits 50 can be disposed in an area over display substrate 12 formed or defined by a convex hull that includes the array of light emitters 18.

In some embodiments and as shown in FIG. 14B, display substrate 12 is not a semiconductor and binary display pixels 14 comprise a pixel substrate 13 in or on which single-bit storage circuits 50 and light emitters 18 are disposed. Pixel substrate 13 is then disposed on and non-native to display substrate 12. In some embodiments, pixel substrate 13 comprises a semiconductor material, single-bit storage circuit 50 is formed in and native to pixel substrate 13, and light emitters 18 are disposed on, e.g., by micro-transfer printing, and non-native to pixel substrate 13. Light emitters 18 can be electrically connected with electrodes 19 to single-bit storage circuits 50 and to external connections on display substrate 12 (not shown in FIG. 14B).

In some embodiments and as shown in FIG. 14C, display substrate 12 is not a semiconductor and both single-bit storage circuit 50 and light emitters 18 are disposed on and non-native to display substrate 12, for example by micro-transfer printing from corresponding source wafers to display substrate 12. Light emitters 18 and single-bit storage circuits 50 can be electrically insulated with dielectric structures 17 exposing contact pads electrically connected to contact pads disposed on display substrate 12 with electrodes 19.

In some embodiments of the present disclosure, binary camera pixels 24 and photodetectors 28 (or photosensors 29) can be disposed on or in camera substrate 22 in a variety of ways. In some embodiments and as shown in FIG. 15A, binary-pixel camera 20 comprises a camera substrate 22 comprising a semiconductor and the array of single-bit storage circuits 50 is formed in or on and is native to camera substrate 22. The array of photodetectors 28 can be disposed on and non-native to camera substrate 22, e.g., by micro-transfer printing. Each photodetector 28 can be insulated with a dielectric structure 17 and can comprise a photodetector contact pad electrically connected to a substrate contact pad with an electrode 19 that contacts both the photodetector contact pad and the substrate contact pad and is patterned over dielectric structure 17. The substrate contact pad can be electrically connected to single-bit storage circuit 50. In some embodiments, for example to increase binary-pixel camera 20 resolution, photodetectors 28 can be disposed on or over single-bit storage circuits 50, as shown in FIG. 15A, reducing the area on camera substrate 22 needed for each binary camera pixel 24 and increasing binary-pixel camera 20 resolution. Thus, one or more (e.g., all) of single-bit storage circuits 50 in the array of single-bit storage circuits 50 is disposed in an area over camera substrate 22 formed or defined by a convex hull that includes the array of photodetectors 28.

In some embodiments and as shown in FIG. 15B, camera substrate 22 is not a semiconductor and binary camera pixels 24 comprise a pixel substrate 13 in or on which single-bit storage circuits 50 and photodetectors 28 are disposed. Pixel substrate 13 is then disposed on and non-native to camera substrate 22. In some embodiments, pixel substrate 13 comprises a semiconductor material, single-bit storage circuit 50 is formed in and native to pixel substrate 13, and photodetectors 28 are disposed on, e.g., by micro-transfer printing, and non-native to pixel substrate 13. Photodetectors 28 can be electrically connected with electrodes 19 to single-bit storage circuits 50 and to external connections on camera substrate 22 (not shown in FIG. 15B).

In some embodiments and as shown in FIG. 15C, camera substrate 22 is not a semiconductor and both single-bit storage circuit 50 and photodetectors 28 are disposed on and non-native to camera substrate 22, for example by micro-transfer printing from corresponding source wafers to camera substrate 22. Photodetectors 28 and single-bit storage circuits 50 can be electrically insulated with dielectric structures 17 exposing contact pads electrically connected to contact pads disposed on camera substrate 22 with electrodes 19.

In some embodiments and as shown in FIG. 15D, the array of photodetectors 28 can be formed in or on and is native to display substrate 12, for example where a semiconductor material 18 (such as silicon) is comprised in both photodetectors 28 and camera substrate 22. Single-bit storage circuits 50 can also be comprised in and native to camera substrate 22. Electrodes 19 insulated by dielectric structures 17 can conduct signals to and from photodetectors 28, single-bit storage circuits 50, and external circuits (such as camera controller 71). Similarly, where camera substrate 22 is not a semiconductor but pixel substrate 13 is a semiconductor, such as silicon, both single-bit storage circuit 50 and photodetector 28 (or photosensor 29) can be comprised in and native to pixel substrate 13 (as shown in FIG. 15E).

In some embodiments, pixel substrate 13 is a cluster substrate and cluster controller 82 and binary display or binary camera pixels 14, 24 are disposed in or on pixel substrate 13 as a cluster 80. If pixel substrate 13 (or cluster substrate) comprises a semiconductor such as silicon, cluster controller 82 can be comprised in and native to pixel substrate 13 (or cluster substrate) and does not comprise a tether 92.

Micro-transfer-printed light emitters 18 can each be an integrated circuit and can comprise a fractured or separated tether 92 as a consequence of micro-transfer printing light emitters 18 from a source light-emitter wafer to pixel substrate 13 (or display substrate 12). Similarly, micro-transfer-printed photodetectors 28 or photosensors 29 can each be an integrated circuit and can comprise a fractured or separated tether 92 as a consequence of micro-transfer printing photodetectors 28 or photosensors 29 from a source wafer to pixel substrate 13 (or display substrate 12). Likewise, single-bit storage circuits 50 can each be a micro-integrated circuit and comprise a fractured or separated tether 92 as a consequence of micro-transfer printing light emitters 18 from a source wafer to display substrate 12 (or to pixel substrate 13 where pixel substrate 13 is not a semiconductor and single-bit storage circuit 50 is non-native to pixel substrate 13, not shown in the Figures). In some embodiments, cluster controllers 82 are micro-integrated circuits disposed between binary pixels in pixel area 16 and micro-transfer-printed and non-native to display substrate 12 or camera substrate 22 and can therefore also comprise fractured or separated tethers 92 as a consequence of micro-transfer printing cluster controllers 82 from a source wafer to display substrate 12 or camera substrate 22.

Individual elements of binary-pixel optical communication system 90 can be constructed using photolithographic methods and materials known in the integrated circuit, display, camera, and optical communication arts. The elements can be assembled on corresponding substrates using micro-transfer printing, printed-circuit board assembly processes such as pick-and-place and surface-mount technologies.

Binary-pixel display 10 can be at a first location and binary-pixel camera 20 can be at a second location different from the first location so that information included in the image can be communicated, for example through free space, from the first location to the second location. A first computer or telecommunication system can be electrically or optically connected to binary-pixel display 10 and a second different computer or telecommunication system can be electrically or optically connected to binary-pixel camera 20 to communicate information from the first computer or telecommunication system to the second computer or telecommunication system. Information can be encoded in the image by the first computer or telecommunication system and the information can be decoded from the image by the second computer or telecommunication system.

In some embodiments of the present disclosure, an optical system 36 images, conducts, or transmits light 30 emitted from binary-pixel display 10 onto binary-pixel camera 20 where light 30 is captured to produce an image on binary-pixel camera 20 corresponding to binary image 40 displayed on binary-pixel display 10. For example, optical system 36 can be an optical imaging system comprising a lens or collection of lenses or mirrors. Optical system 36 can be separate from or attached to or a part of binary-pixel camera 20. Binary-pixel display 10 can comprise a collection of micro-light-emitting diodes 18 (for example in a two-dimensional array) for displaying an input binary image 40 and binary-pixel camera 20 can comprise a collection of CMOS photosensors 29 (for example in a two-dimensional array) for capturing binary image 40. Two-dimensional binary pixel arrays are easier to optically image from binary-pixel display 10 to binary-pixel camera 20. Binary image 40 captured by binary-pixel camera can be provided to a computer for analysis or action.

All of binary display pixels 14 can emit light 30 at a same time (e.g., as an image frame) within the limitations of control circuit and signal propagation times using direct access to binary display pixels 14 or using matrix addressing. Similarly, all of binary camera pixels 24 can be captured at a same time (e.g., as an image frame) within the limitations of control circuit and signal propagation times using direct access to binary camera pixels 24 or using matrix addressing, for example using a mechanical or electronic shutter. Captured binary image 40 can be processed to extract the binary information and output the binary information, for example as an output image to a computer or telecommunication system connected to binary-pixel camera 20. The process can then repeat with a new input binary image 40 and new information. In some embodiments, the displaying of an image using binary-pixel display 10 and recording of the image using binary-pixel camera 20 can be done an image at a time, so that methods can comprise recording all of binary camera pixels 24 at a first time or during a first period before recording one or more of binary camera pixels 24 at a second time after the first time or during a second period after the first period.

Binary camera pixels 24 in binary-pixel camera 20 can be substantially identical, e.g., within manufacturing limits. Similarly, binary display pixels 14 in binary-pixel display 10 can be substantially identical, e.g., within manufacturing limits. In some embodiments, binary-pixel camera 20 or binary-pixel display 10 can comprise no fewer than 9, 16, 25, 100, 400, 900, 1600, 2500, 5625, or 10000 binary pixels, respectively, arranged in rows or columns having no fewer than 3, 5, 10, 25, 100, 200, 300, 400, or 500 binary pixels in each row or column.

According to embodiments of the present disclosure, all of binary display pixels 14 are controlled to emit light 30 in response to a single constant image frame for a frame period of time, for example using display cluster controllers 82. Different images can be displayed with binary display pixels 14 of binary-pixel display 10 during different frame periods, for example successive frame periods as in a video or film. Successive frame periods can have a constant duration, e.g., the frame periods can all have the same temporal duration (can take or extend over the same time). In some embodiments, the frame periods all have at least a minimum temporal duration, for example a time required to update (display) all of binary display pixels 14 in binary-pixel display 10 or a time required to store image data for all of binary display pixels 14, e.g., stored in a frame store associated with or comprised in binary-pixel display 10, stored in a memory in display cluster controllers 82, or stored in a memory in display cluster controllers 82. In some embodiments, the frame periods have variable temporal duration, but all at least are no less than the minimum temporal duration.

Similarly, in some embodiments, binary-pixel camera 20 can capture or record a single image comprising data for each binary camera pixel 24 and each binary camera pixel 24 is similarly controlled, albeit with different pixel data, to absorb, record, or capture the single image. Thus, in some embodiments, binary camera pixels 24 are functionally similar, operate substantially similarly in response to pixel data, and provide a similar function, e.g., recording or capturing image data, where the image data comprises pixel data for each binary camera pixel 24 in an image exposed onto binary-pixel camera 20. In some embodiments, pixel data in an image can comprise a different or same value for any binary camera pixels 24 captured or recorded on binary-pixel camera 20.

According to embodiments of the present disclosure, all of binary camera pixels 24 are controlled to capture light 30 in response to a single constant image exposed onto binary camera pixels 24 from binary-pixel display 10 for a frame period of time, for example using camera cluster controllers 82. Different images can be recorded with binary camera pixels 24 of binary-pixel camera 20 during different frame periods, for example successive frame periods as in a video or film. Successive frame periods can have a constant duration, e.g., the frame periods can all have the same temporal duration (can take or extend over the same time). In some embodiments, the frame periods all have at least a minimum temporal duration, for example a time required to update (capture) all of binary camera pixels 24 in binary-pixel camera 20 or a time required to store captured image data for all of binary camera pixels 24, e.g., stored in a frame store associated with or comprised in binary-pixel camera 20, or stored in a memory in camera cluster controllers 82. In some embodiments, the frame periods have variable temporal duration, but all at least are no less than the minimum temporal duration. In some embodiments, the temporal frame rate for binary-pixel camera 20 is the same as or greater than the temporal frame rate for binary-pixel display 10 (e.g., the frame period for binary-pixel camera 20 is equal to or less than the frame period for binary-pixel display 10).

A single image frame comprises pixel data displayed for a frame period during which each binary display pixel 14 in binary-pixel display 10 emits light 30 or binary camera pixel 24 in binary-pixel camera 20 captures light 30 corresponding to a pixel value of the single constant image frame. In some embodiments, the pixel data (pixel value) during the frame period does not change (although some embodiments require that light 30 is emitted or captured for only a portion of the frame period, for example with passive-matrix control in which light 30 is emitted or captured in successive rows or with active-matrix control which the data is updated by or stored in successive rows.

In some embodiments, the image frame data (the picture, image, pixel values, or pixel data) supplied to binary-pixel display 10 or captured by binary-pixel camera 20 does not change during the frame period. The frame period is defined as the temporal period during which the image frame data does not change. Thus, binary display pixels 14 or binary camera pixels 24 can be controlled to emit or capture light 30 in response to an unchanging, constant image frame comprising an image pixel value for each binary display pixel 14 or binary camera pixel 24 during a temporal frame period.

In some embodiments, exclusive groups of binary display or camera pixels 14, 24 are disposed in a pixel cluster 80 that can all be controlled by a common cluster controller 82, e.g., providing direct, active-matrix, or passive-matrix pixel control to binary display or binary camera pixels 14, 24 in pixel cluster 80. Rows of cluster controllers 82 can be connected in common to row wires 62 and columns of cluster controllers 82 can be connected in common to column wires 60. A row controller 72 can provide row-control signals to cluster controller 82 on row wires 62 and a column controller 74 can provide column-data signals to cluster controller 82 on display column wires 60. (Row controllers 72 and column controllers 74 can be comprised in a cluster controller 82.) Cluster controllers 82 can generate pixel control signals (e.g., direct, active-matrix, or passive-matrix) to individual binary display or binary camera pixels 14, 24 in pixel clusters 80. Pixel clusters 80 can be arranged in a regular array over display or camera substrate 12, 22. In some embodiments, cluster controllers 82 can be arranged in a regular array on or over display substrate 12 or camera substrate 22.

Row wires 62 and column wires 60 can be connected to an external controller, for example a display controller 70 or camera controller 71 using row controllers 72 and column controllers 74 that provide matrix control to binary display pixels 14 or binary camera pixels 24, for example as shown in FIG. 5 (for binary-pixel displays 10) and FIG. 10 (for binary-pixel cameras 20) through row wires 62 and column wires 60. (Display or camera controllers 70, 71 can comprise row and column controllers 72, 74.) In some embodiments, control wires 61 provide direct control to binary display pixels 14 or binary camera pixels 24, for example as shown in FIG. 4 (for binary-pixel displays 10 using display controller 70) and FIG. 9 (for binary-pixel cameras 20 using camera controller 71).

In some embodiments, binary display pixels 14 or binary camera pixels 24 in clusters 80 can be directly controlled by cluster controllers 82 through cluster control wires 87, as shown in FIG. 6 for binary-pixel displays 10 or as shown in FIG. 11 for binary-pixel cameras 20. In some embodiments, binary display pixels 14 and binary camera pixels 24 in clusters 80 can be matrix controlled by cluster controllers 82 through cluster column wires 86 and cluster row wires 88, as shown in FIG. 12.

In some embodiments, clusters 80 are directly controlled by display controller 70 or camera controller 71 and binary display pixels 14 or binary camera pixels 24 in clusters 80 are directly controlled by cluster controllers 82. In some embodiments, clusters 80 are directly controlled by display controller 70 or camera controller 71 and binary display pixels 14 or binary camera pixels 24 in clusters 80 are matrix controlled by cluster controllers 82. In some embodiments, clusters 80 are matrix controlled by display controller 70 or camera controller 71 and binary display pixels 14 or binary camera pixels 24 in clusters 80 are directly controlled by cluster controllers 82. In some embodiments, clusters 80 are matrix controlled by display controller 70 or camera controller 71 and binary display pixels 14 or binary camera pixels 24 in clusters 80 are matrix controlled by cluster controllers 82.

Display or camera substrate 12, 22 can be any useful substrate, for example as found in the integrated circuit, digital display, or digital camera industries, for example comprising silicon, glass, plastic, or quartz. A display controller 70 or camera controller 71 can be disposed on display or camera substrate 12, 22 or off display or camera substrate 12, 22, and can comprise one or more integrated circuits, for example a row controller 72 integrated circuit connected to row wires 62 and a column-data controller 74 integrated circuit connected to display column wires 60. In some embodiments, display or camera substrate 12, 22 is a semiconductor substrate, for example silicon, and cluster controllers 82 or individual binary pixel controllers are formed in or on and native to the semiconductor substrate. In some embodiments, display or camera substrate 12, 22 is not a semiconductor substrate but is a dielectric substrate, for example glass or plastic, and cluster controllers 82 are formed in a thin-film layer on display or camera substrate 12, 22, for example with thin-film transistors. In some embodiments, display or camera substrate 12, 22 is not a semiconductor substrate but is a dielectric substrate, for example glass or plastic, and cluster controllers 82 are integrated circuits having a substrate separate and independent, non-native to, and disposed on display or camera substrate 12, 22, for example one or more silicon CMOS integrated circuits disposed on display or camera substrate 12, 22 by micro-transfer printing.

Binary camera pixels 24 can comprise one or more light sensors (e.g., photosensors 29 that can capture or record light 30 incident on binary camera pixels 24), such as a photodiode or phototransistor. Each binary camera pixel 24 can be individually controlled to absorb, capture, or record light 30 corresponding to a pixel value in a binary image 40 during an image frame period. Row and column wires 62, 60, control wires 61, cluster row and cluster column wires 88, 86, and cluster control wires 87 can be formed on display or camera substrate 12, 22 (or an intermediate pixel substrate 13 or cluster substrate) using photolithographic or inkjet methods and materials. In some embodiments, photosensors 29 can be disposed on camera substrate 22 by micro-transfer printing. In some embodiments, photosensors 29 can be disposed by micro-transfer printing photosensors 29 onto an intermediate pixel substrate 13 or cluster substrate separate and independent from and disposed on camera substrate 22. Similarly, camera cluster controller 82, if present, can be disposed on camera substrate 22 by micro-transfer printing or can be disposed by micro-transfer printing onto an intermediate pixel substrate 13 or cluster substrate disposed on camera substrate 22.

Binary display pixels 14 can comprise one or more light emitters 18, such as inorganic micro-light-emitting diodes 18 comprising a compound semiconductor material that can each emit an amount of light 30 that can be, but is not necessarily, different from the amount of light 30 emitted by any other active binary display pixel 14. Each binary display pixel 14 can be individually controlled to emit light 30 corresponding to a pixel value in a binary image 40 during an image frame period. Row and column wires 62, 60, control wires 61, cluster row and cluster column wires 88, 86, and cluster control wires 87 can be formed on display substrate 12 (or an intermediate pixel substrate 13 or cluster substrate) using photolithographic or inkjet methods and materials. In some embodiments, light emitters 18 can be disposed on display substrate 12 by micro-transfer printing. In some embodiments, light emitters 18 can be disposed by micro-transfer printing light emitters 18 onto an intermediate pixel substrate 13 or cluster substrate separate and independent from and disposed on display substrate 12. Similarly, display cluster controller 82, if present, can be disposed on display substrate 12 by micro-transfer printing or can be disposed by micro-transfer printing onto an intermediate pixel substrate 13 or cluster substrate disposed on display substrate 12.

Binary camera pixels 24 can comprise monochrome binary camera pixels 24 that absorb a single color of light 30 (or white light 30) or comprise color binary camera pixels 24 that absorb multiple, different colors of light 30. In some embodiments, monochrome binary camera pixels 24 can comprise a single light absorber, for example a single photodiode that absorbs a single color or white light 30. In some embodiments, binary camera pixels 24 are color binary camera pixels 24 that can comprise multiple subpixel photosensors 29, for example multiple photosensors 29 that can each be individually controlled or responded to and that can each absorb a different color of light and provide a different communication channel, for example a red subpixel that can absorb red light 30, a green subpixel that can absorb green light 30, and a blue subpixel that can absorb blue light 30.

Binary display pixels 14 can comprise monochrome binary display pixels 14 that emit a single color of light 30 or comprise color binary display pixels 14 that emit multiple, different colors of light 30. In some embodiments, monochrome binary display pixels 14 can comprise a single light controller, for example a single light-emitting diode 18 that emits a single color. In some embodiments, binary display pixels 14 are color binary display pixels 14 that can comprise multiple subpixel light controllers, for example multiple light-emitting diodes 18, that can each be individually controlled and that can each emit a different color of light 30 and provide a different communication channel, for example a red subpixel that can emit red light 30, a green subpixel that can emit green light 30, and a blue subpixel that can emit blue light 30.

Digital binary-pixel camera 20 is any camera capable of digitally capturing and recording an image with an array of binary camera pixels 24, each binary camera pixel 24 operable to record a portion of binary image 40 exposed onto the array of binary camera pixels 24, e.g., with an optical system 36 comprising one or more lenses. Digital binary-pixel camera 20 can have more binary camera pixels 24 than binary-pixel display 10 has binary display pixels 14 so that digital binary-pixel camera 20 can record each of binary display pixels 14 with at least one and optionally multiple binary camera pixels 24. Digital binary-pixel camera 20 can be a black-and-white camera, can be responsive to only a single color of light 30, or can be a color digital binary-pixel camera 20 responsive to different colors of light 30 to record a color image. In some embodiments, binary camera pixels 24 each comprise a single photodetector 28 (such as a CCD or CMOS photodiode, phototransistor, or other light sensor) responsive to light 30 or a color of light 30. In some embodiments, binary camera pixels 24 each comprise multiple photodetectors 28 (such as CCD or CMOS photosensors 32, photodiodes, phototransistors, or other light sensors) each responsive to a different color (frequency) of light 30 (for example are exposed to light 30 through different color filters). In some embodiments, digital binary-pixel camera 20 detects only white light 30, only green light 30, only infrared light 30, only blue light 30, or only ultraviolet light 30 emitted from binary camera pixels 24 of binary-pixel camera 20.

In some embodiments, digital binary-pixel camera 20 has an image capture (recording) frame rate equal to or greater than a display frame rate of binary-pixel display (e.g., a camera frame rate equal to or faster than a display frame rate at which binary-pixel display 10 receives and displays input binary images 40, e.g., one and a half or twice as fast). Digital binary-pixel camera 20 can be temporally synchronized with digital binary-pixel display 10, even if binary-pixel camera 20 temporally oversamples image frames displayed on binary-pixel display 10. Digital binary-pixel camera 20 can be implemented with a state machine or computing circuits in digital binary-pixel camera 20 to capture and analyze the captured binary image 40, e.g., using image processing to form a processed captured binary image 40.

Binary-pixel optical communication system 90 can comprise a binary-pixel display 10 and digital binary-pixel camera 20 system, for example each disposed on a printed circuit board or wafer and comprising digital integrated circuits and optical components such as lenses for directing light 30. Optical system 36 can be integrated into binary-pixel camera 20 and can comprise lenslets, each lenslet optically associated with a binary camera pixel 24 or subset of binary camera pixels 24 receiving light from a binary display pixel 14.

In some embodiments of the present disclosure, images can be binary images 40 displayed with binary display pixels 14 of binary-pixel display 10 that are either on or off. Such embodiments can be efficient if binary display pixels 14 comprise iLEDs 18 operated at a single desired current density. Similarly, digital binary-pixel camera 20 can be a black-and-white camera that provides a binary output in response to light 30 exposure. In some embodiments, digital binary-pixel camera 20 is a binary camera that captures and records binary optical signals.

Having described certain implementations of embodiments, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific elements, or where processes and methods are described as having, including, or comprising specific steps, it is contemplated that, additionally, there are apparatus and systems of the disclosed technology that consist essentially of, or consist of, the recited elements, and that there are processes and methods according to the disclosed technology that consist essentially of, or consist of, the recited processing steps.

It should be understood that the order of steps or order for performing certain action is immaterial so long as operability is maintained. Moreover, two or more steps or actions in some circumstances can be conducted simultaneously. The disclosure has been described in detail with particular reference to certain embodiments thereof, but it will be understood that variations and modifications can be effected within the spirit and scope of the disclosure.

### PARTS LIST

RC read control
WC write control
binary-pixel display
12 display substrate
13 pixel substrate
14 binary display pixel
16 pixel area
17 dielectric structure
18 light-emitting diode/light emitter
19 electrode
20 binary-pixel camera
22 camera substrate
24 binary camera pixel
28 photodetector
29 photosensor/photodiode/phototransistor
30 light
32 photosignal
36 optical system/lens
40 binary image
50 single-bit storage circuit
51 first logic inverter
52 second logic inverter
54 write-control transistor
56 read-control transistor
58 inverted write-control transistor
59 amplification transistor
60 column wire
61 control wire
62 row wire
70 display controller
71 camera controller
72 row controller
74 column controller
80 pixel cluster/cluster
82 cluster controller
86 cluster column wire
87 cluster control wire
88 cluster row wires
90 binary-pixel optical communication system
92 tether
100 provide binary-pixel communication system step
110 input binary image to binary-pixel display step
120 store binary pixels in single-bit storage circuit step
130 display image on binary-pixel display step
140 capture binary image with binary-pixel camera step
150 store binary pixels in single-bit storage circuit step
160 output binary image from binary-pixel camera step

1. A binary-pixel optical communication system, comprising:
a binary-pixel display comprising binary display pixels operable to display a binary image; and
a binary-pixel camera comprising binary camera pixels disposed to optically receive the binary image and operable to record the binary image.

2. The binary-pixel optical communication system of claim 1, wherein a number or a spatial resolution of the binary display pixels is spatially matched to a number or spatial resolution of the binary camera pixels, respectively.

3. The binary-pixel optical communication system of claim 1, wherein spatial resolution of the binary display pixels is geometrically similar to spatial resolution of the binary camera pixels.

4. The binary-pixel optical communication system of claim 1, wherein each of the binary display pixels is optically imaged to a different one of the binary camera pixels.

5. The binary-pixel optical communication system of claim 1, wherein, for at least one of the binary display pixels, the binary display pixel is optically imaged to at least one group of multiple, adjacent binary camera pixels.

6. The binary-pixel optical communication system of claim 5, wherein the multiple, adjacent binary camera pixels form a two-dimensional array.

7. The binary-pixel optical communication system of claim 1, wherein (i) the binary-pixel display is operable to display a binary image at a display frame rate and (ii) the binary-pixel camera comprises a camera sensor and a camera controller that is operable to control the camera sensor to record a binary image at a camera frame rate that is equal to or greater than the display frame rate.

8. The binary-pixel optical communication system of claim 7, wherein the camera frame rate is equal to or greater than twice the display frame rate.

9. A display, comprising:
an array of single-bit storage circuits, each single-bit storage circuit operable to store a single bit of information corresponding to a binary image pixel of a binary image and output the stored single bit of information; and
an array of light emitters, wherein for each of the light emitters, the light emitter is connected to a single-bit storage circuit of the single-bit storage circuits and operable to emit light corresponding to the output from the single-bit storage circuit.

10-11. (canceled)

12. The display of claim 9, comprising binary display pixels each comprising one of the light emitters and one of the single-bit storage circuits.

13-14. (canceled)

15. The display of claim 9, comprising binary display pixels each comprising only one of the light emitters and only one of the single-bit storage circuits.

16-17. (canceled)

18. The display of claim 9, wherein each light emitter in the array of light emitters is separately connected to a corresponding single-bit storage circuit of the single-bit storage circuits.

19-20. (canceled)

21. The display of claim 9, comprising a display controller, wherein the single-bit storage circuits are separately connected to the display controller.

22. The binary-pixel display of claim 9, comprising a display substrate comprising a semiconductor, wherein (i) the array of single-bit storage circuits is native to the display substrate and (ii) the array of light emitters is disposed on and non-native to the display substrate.

23. The binary-pixel display of claim 22, wherein one or more of the single-bit storage circuits is disposed in an area over the display substrate defined by a convex hull of the array of light emitters.

24. The binary-pixel display of claim 9, comprising a display substrate comprising a semiconductor, wherein (i) the array of single-bit storage circuits is native to the display substrate and (ii) the array of light emitters is formed in or on and is native to the display substrate.

25. The binary-pixel display of claim 9, comprising a display substrate and wherein (i) the array of single-bit storage circuits is disposed on and is non-native to the display substrate and (ii) the array of light emitters is disposed on and non-native to the display substrate.

26. The binary-pixel display of claim 25, wherein one or more of the single-bit storage circuits in the array of single-bit storage circuits is disposed in an area over the display substrate defined by a convex hull of the array of light emitters.

27. The binary-pixel display of claim 9, wherein one or more of the single-bit storage circuits in the array of single-bit storage circuits comprise a micro-integrated circuit comprising a fractured or separated tether.

28. A binary display pixel, comprising:
a single-bit storage circuit operable to receive a single bit of information and store the single bit of information; and
a light emitter responsive to the single bit of information stored in the single-bit storage circuit to emit light.

29-70. (canceled)
